(19) United States
(12) Patent Application Publication
(10) Pub. No.: US 2018/0184088 A1
(43) Pub. Date: Jun. 28, 2018

(54) VIDEO DATA ENCODER AND METHOD OF ENCODING VIDEO DATA WITH SAMPLE ADAPTIVE OFFSET FILTERING

(71) Applicant: SAMSUNG ELECTRONICS CO., LTD., Suwon-si (KR)

(72) Inventor: Ju-won BYUN, Hwaseong-si (KR)

(73) Assignee: SAMSUNG ELECTRONICS CO., LTD., Suwon-si (KR)

(21) Appl. No.: 15/652,760

(22) Filed: Jul. 18, 2017

(30) Foreign Application Priority Data
Dec. 23, 2016 (KR) 10-2016-0177939

(51) Int. Cl. H04N 19/124; H04N 19/117

(52) U.S. Cl. CPC H04N 19/124; H04N 19/117

(57) ABSTRACT

A video data encoder and an encoding method for performing a sample adaptive offset (SAO) filtering having improved coding efficiency based on a dynamic range of a plurality of offsets determined according to a quantization parameter.

### CROSS-REFERENCE TO RELATED APPLICATION

This application claims priority from Korean Patent Application No. 10-2016-0177939, filed on Dec. 23, 2016, in the Korean Intellectual Property Office, the disclosure of which is incorporated herein in its entirety by reference.

### BACKGROUND

Methods and apparatuses consistent with exemplary embodiments of the present application relate to a video data encoder and a method of encoding video data including a sample adaptive offset (SAO) filtering operation according to offsets having a variable dynamic range.

With the development and dissemination of hardware capable of reproducing and storing high-resolution or high-definition video content, there is a growing need for a video codec capable of effectively encoding or decoding high-resolution or high-definition video content. According to conventional video codecs, video is encoded according to a limited encoding method based on a predetermined size of encoding data.

In particular, during video encoding and decoding operations, in order to minimize an error between an original image and a restored image, a method of adjusting a restored pixel value by using adaptively determined offsets may be applied.

### SUMMARY

Exemplary embodiments of the present application relate to a video data encoder, and more particularly, a video data encoder and an encoding method for performing a sample adaptive offset (SAO) filtering having improved coding efficiency.

According to an aspect of an exemplary embodiment, there is provided a method of encoding video data including: determining a range of a plurality of offsets based on a quantization parameter; determining values of offsets in the range of the plurality of offsets based on a sample adaptive offset (SAO) mode; and performing SAO compensation on pixels of a coding unit based on the values of the offsets.

According to an aspect of an exemplary embodiment, there is provided a video data encoder including: a memory configured to store computer-readable instructions for encoding video data; and a processor configured to execute the computer-readable instructions to implement: a quantizer configured to quantize the video data based on a quantization parameter; and a sample adaptive offset (SAO) filter configured to perform SAO filtering on pixels of a coding unit of the quantized video data according to values of offsets in a range of offsets determined based on the quantization parameter.

According to an aspect of an exemplary embodiment, there is provided a video encoding method including: determining a range of offsets based on a quantization parameter (QP), determining sample adaptive offset (SAO) values of bands of offsets in the range of offsets based on errors between original samples and restored samples in the bands of offsets, determining an SAO edge type of a sample of a coding unit to be encoded, determining a sample band among the bands of offsets which the sampled pixel belongs based on SAO edge type, determining an SAO value to be applied for SAO compensation on the sample based on the SAO value of the sample band among the bands of offsets to which the sample belongs, and performing SAO compensation on the sample based on the SAO value.

### BRIEF DESCRIPTION OF THE DRAWINGS

Exemplary embodiments of the present disclosure will be more clearly understood from the following detailed description taken in conjunction with the accompanying drawings in which:

FIG. 1 is a block diagram of a video data encoder according to an exemplary embodiment;

FIG. 2 is a graph of experimental results of a distribution of offset values according to quantization parameters, according to an exemplary embodiment;

FIG. 3A is a block diagram of a sample adaptive offset (SAO) filter according to an exemplary embodiment;

FIG. 3B is a graph showing a dynamic range of offsets that varies based on a quantization parameter, according to an exemplary embodiment;

FIG. 4A is a block diagram of a dynamic range determiner shown in FIG. 3A according to an exemplary embodiment;

FIG. 4B is a table of the dynamic range determiner shown in FIG. 3A according to an exemplary embodiment;

FIG. 5A is a diagram of edge classes of an SAO edge type;

FIGS. 5B and 5C are views of SAO categories of the SAO edge type;

FIG. 5D is a view of an SAO category of a SAO band type;

FIG. 6 is a block diagram of a video data decoder according to an exemplary embodiment;

FIG. 7 is a diagram of a coding unit according to an exemplary embodiment;

FIG. 8 is a flowchart of an operation of an SAO filter according to an exemplary embodiment;

FIG. 9 is a flowchart of determining values of offsets, according to an exemplary embodiment; and

FIG. 10 illustrates a mobile terminal equipped with a video data encoder according to an exemplary embodiment.

### DETAILED DESCRIPTION OF EXEMPLARY EMBODIMENTS

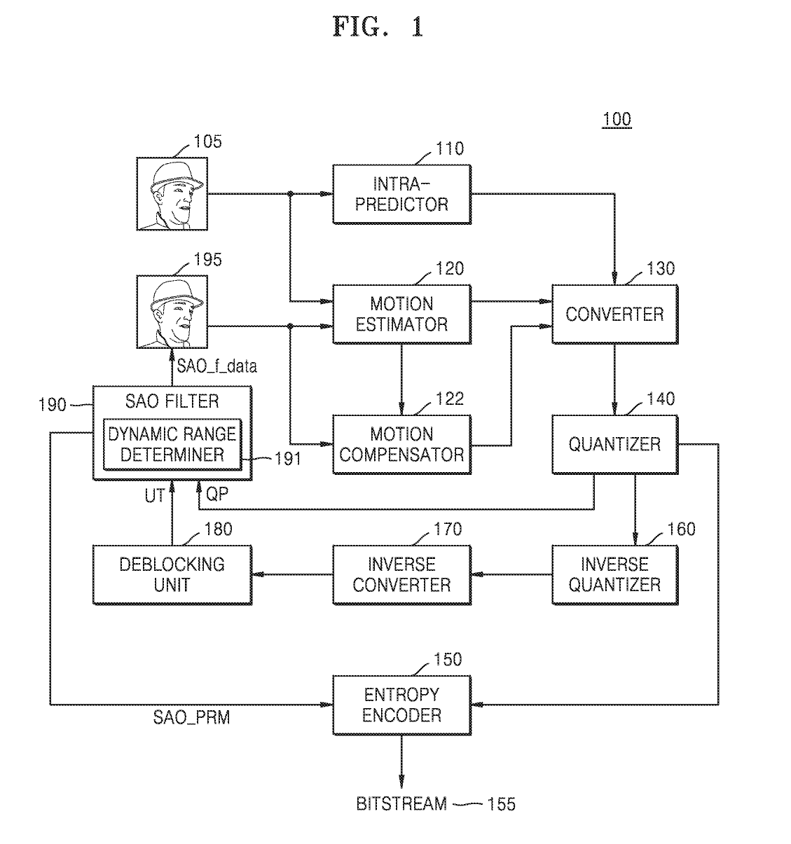

FIG. 1 is a block diagram of a video data encoder according to an exemplary embodiment.

A video data encoder according to an exemplary embodiment may receive video images, divide each of the video images into, for example, largest coding units, and perform prediction, conversion, and entropy encoding on samples for each largest coding unit. Thus, generated result data may be output as bitstream type data. The samples of the largest coding unit may be pixel value data of pixels constituting the largest coding unit.

Video images may be converted into coefficients in a frequency domain using frequency conversion. The video data encoder may divide an image into predetermined blocks for fast calculation of the frequency conversion, perform the frequency conversion for each block, and encode frequency coefficients in block units. The coefficients in the frequency domain may be compressed more easily than image data in a spatial domain. Because an image pixel value in the spatial domain is represented by a prediction error through inter-prediction or intra-prediction of the video data encoder, many pieces of data may be converted to zero if the frequency conversion is performed on the prediction error. The video data encoder may reduce the amount of data by replacing data that is continuously and repeatedly generated with small-size data.

Referring to FIG. 1, the video data encoder 100 may include an intra-predictor 110, a motion estimator 120, and a motion compensator 122. Furthermore, the video data encoder 100 may include a converter 130, a quantizer 140, an entropy encoder 150, an inverse quantizer 160, and an inverse converter 170. In addition, the video data encoder 100 may further include a deblocking unit 180 and a sample adaptive offset (SAO) filter 190.

The intra-predictor 110 may perform intra-prediction on a current frame. The motion estimator 120 and the motion compensator 122 may perform motion estimation and motion compensation using a current frame 105 and a reference frame 195 in an inter-mode.

Data output from the intra-predictor 110, the motion estimator 120, and the motion compensator 122 may be output as a conversion coefficient quantized through the converter 130 and the quantizer 140. The converter 130 may perform frequency conversion on input data and output the data as a conversion coefficient. The frequency conversion may be performed, for example, by using a discrete cosine transform (DCT) or a discrete sine transform (DST).

The quantizer 140 may perform a quantization operation on a conversion coefficient output from the converter 130 through a quantization parameter QP. The quantization parameter QP may be used to determine whether an absolute difference between neighboring samples is greater than a threshold value. The quantization parameter QP may be an integer. In an exemplary embodiment, the quantizer 140 may perform adaptive frequency weighting quantization. The quantizer 140 may output the quantization parameter QP based on the quantization operation to the SAO filter 190 and output the quantized conversion coefficient to the inverse quantizer 160 and the entropy encoder 150, respectively. The quantized conversion coefficient output from the quantizer 140 may be restored as data in a spatial domain through the inverse quantizer 160 and the inverse converter 170 and deblocking filtering may be performed on the restored data in the spatial domain by the deblocking unit 180.

SAO filtering may be performed by the SAO filter 190 on a pixel value on which deblocking filtering has been performed. The SAO filtering classifies pixels constituting a processing unit UT on which filtering is performed, calculates an optimal offset value based on the classified information, and then applies an offset value to a restored pixel to thereby obtain an average pixel distortion in the processing unit UT. The SAO filtering may be, for example, an in-loop process that affects subsequent frames based on an SAO filtered frame. In an example embodiment, the processing unit UT may be a largest coding unit.

The SAO filter 190 may perform SAO filtering on a pixel value on which deblocking filtering has been performed to output SAO filtered data SAO_f_data and form the reference frame 195. The SAO filter 190 may also output an SAO parameter SAO_PRM to the entropy encoder 150. The entropy encoder 150 may output a bitstream 155 including the entropy-encoded SAO parameter SAO_PRM. The bitstream 155 may be, for example, a network abstraction layer (NAL) unit stream capable of indicating video data or a bit string in a form of a byte stream.

The SAO filter 190 may perform SAO adjustment for each color component. For example, for a YCrCb color image, SAO filtering may be performed for each of a luma component (Y component) and first and second chroma components (Cr and Cb components).

The SAO filter 190 according to an exemplary embodiment may determine whether to perform SAO filtering on a luma component of the current frame 105. The SAO filter 190 according to an example embodiment may equally determine whether to perform SAO filtering on first and second chroma components of the current frame 105. That is, if an SAO adjustment is performed for the first chroma color component, the SAO adjustment may also be performed for the second chroma component, and if an SAO adjustment is not performed for the first chroma color component, then the SAO adjustment may also not be performed for the second chroma component.

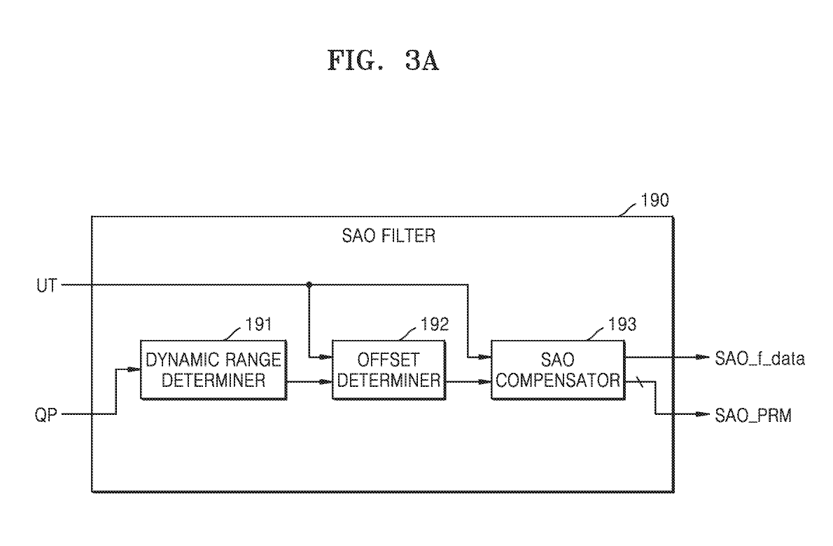

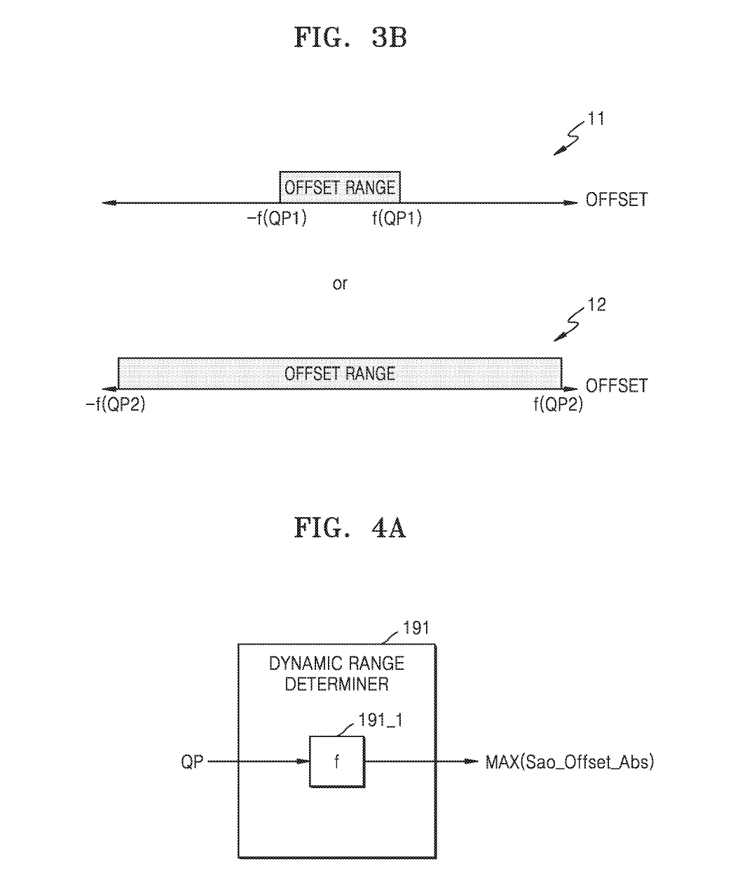

The SAO filter 190 may include a dynamic range determiner 191. The dynamic range determiner 191 may determine a dynamic range of offsets for performing SAO filtering. According to an exemplary embodiment, the dynamic range determiner 191 may determine a dynamic range of a plurality of offsets based on the quantization parameter QP received from the quantizer 140. A detailed description will be provided later below with respect to FIGS. 3A and 3B.

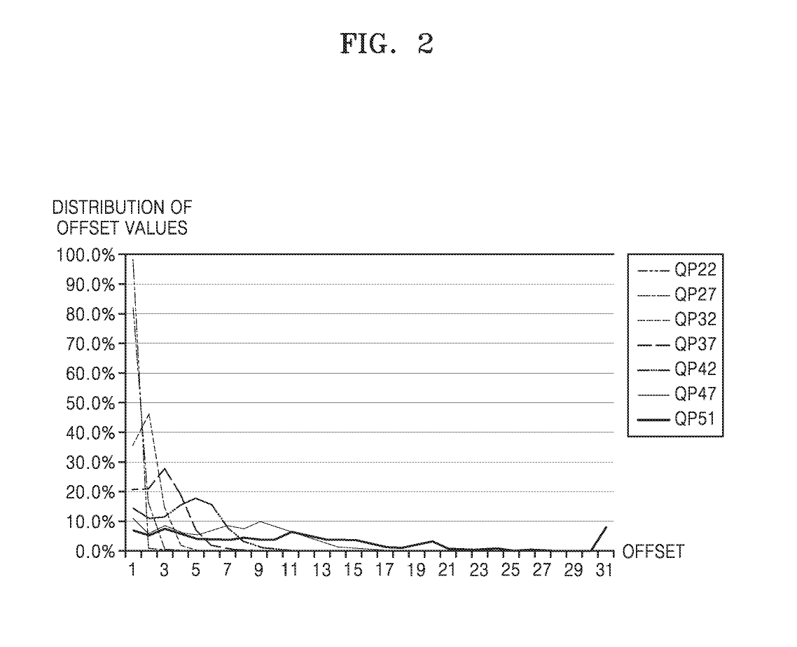

FIG. 2 is a graph of experimental results of a distribution of offset values according to quantization parameters, according to an exemplary embodiment.

The graph of FIG. 2 may be for a distribution of offset values when a different quantization parameter QP (e.g., QP22, QP27, QP32, QP37, QP42, QP47, and QP51) is applied to the same processing unit UT. The processing unit UT may be, for example, a largest encoding unit.

As the quantization parameter QP increases, definition of video data to be encoded may decrease. As the quantization parameter QP decreases, a majority of the offset values required for an SAO filtering operation may be distributed closer to a value of ‘1’. That is, the smaller the quantization parameter QP, the smaller the dynamic range may be required by the offsets.

The larger the quantization parameter QP, the lower the definition of video data to be encoded. The larger the quantization parameter QP, the more the offset values required for the SAO filtering operation may vary compared to when the quantization parameter QP has a smaller value. That is, the larger the quantization parameter QP, the larger a dynamic range may be required by the offsets.

The SAO filter 190 (of FIG. 1) according to an exemplary embodiment may receive a quantization parameter QP for a processing unit UT of a current frame from the quantizer 140 (of FIG. 1) and may determine a dynamic range of offsets according to the quantization parameter QP. Therefore, when the quantization parameter QP has a small value, encoding efficiency in the SAO filtering operation may be enhanced, and when the quantization parameter QP has a large value, an SAO filtering operation with improved compensation may be performed.

FIG. 3A is a block diagram of the SAO filter according to an exemplary embodiment, and FIG. 3B is a graph showing that a dynamic range of offsets that varies based on a quantization parameter, according to an exemplary embodiment.

Referring to FIG. 3A, the SAO filter 190 may include a dynamic range determiner 191, an offset determiner 192, and an SAO compensator 193. The dynamic range determiner 191 may determine a dynamic range of offsets based on the quantization parameter QP. The dynamic range of offsets may vary depending on a maximum value of a parameter indicating information about an offset absolute value, for example, in an SAO compensation for pixels constituting the processing unit UT. In an exemplary embodiment, the maximum value of the parameter indicating the information about an offset absolute value may be derived using the following Equation 1.

Max(Sao_Offset_Abs)=f(QP) [Equation 1]

In Equation 1, Sao_Offset_Abs is, for example, a parameter indicating information about an offset absolute value in a video parameter set VPS of HEVC, f(QP) is a function for the quantization parameter QP, and Max (Sao_Offset_Abs) is a maximum value of the parameter indicating information about the offset absolute value.

A first function value according to a first quantization parameter and a second function value according to a second quantization parameter may be derived from f(QP). In an exemplary embodiment, if the second quantization parameter is greater than the first quantization parameter, the second function value may be equal to or greater than the first function value. In an exemplary embodiment, f(QP) may be derived using the following Equation 2.

f(QP)=ROUND(0.5 e^{0.07*QP}) [Equation 2]

In Equation 2, ROUND is a rounding off operation. The dynamic range determiner 191 may provide the offset determiner 192 with information about an offset absolute value for which a maximum value has been determined.

The offset determiner 192 may respectively determine and output values of offsets for the processing unit UT by using an SAO mode. In an exemplary embodiment, the offset determiner 192 may determine values of offsets for the processing unit UT based on a dynamic range determined by the dynamic range determiner 191. The processing unit UT may be, for example, a largest coding unit.

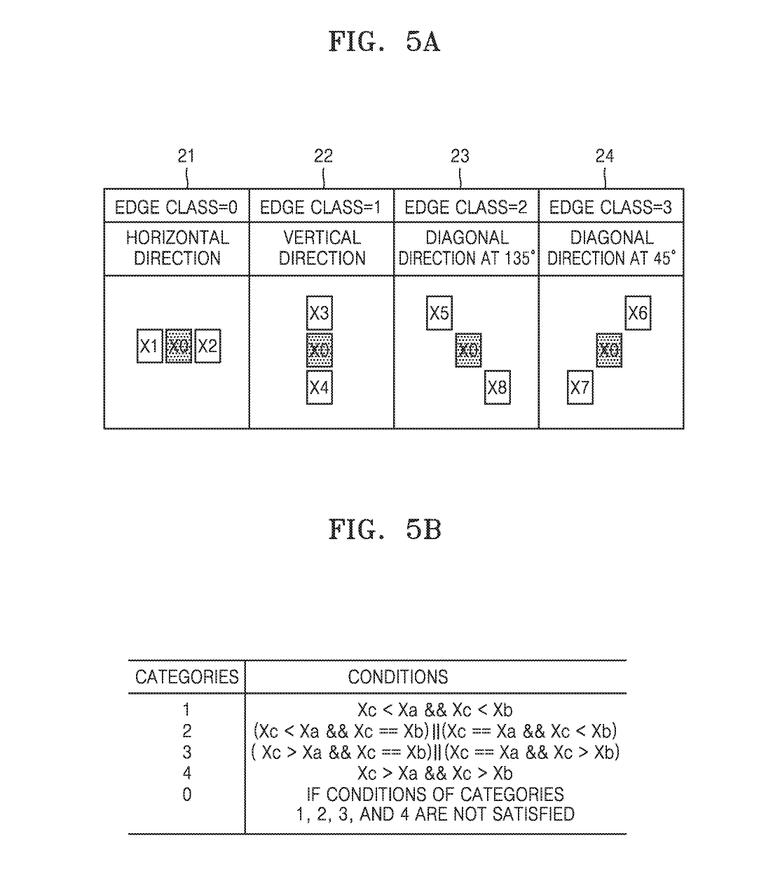

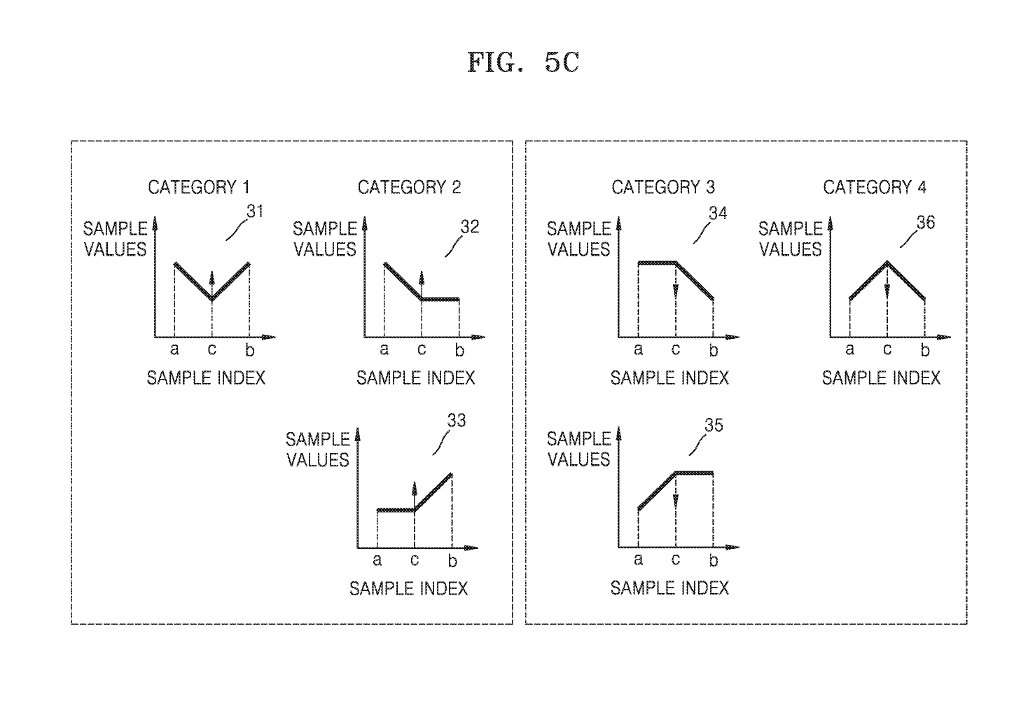

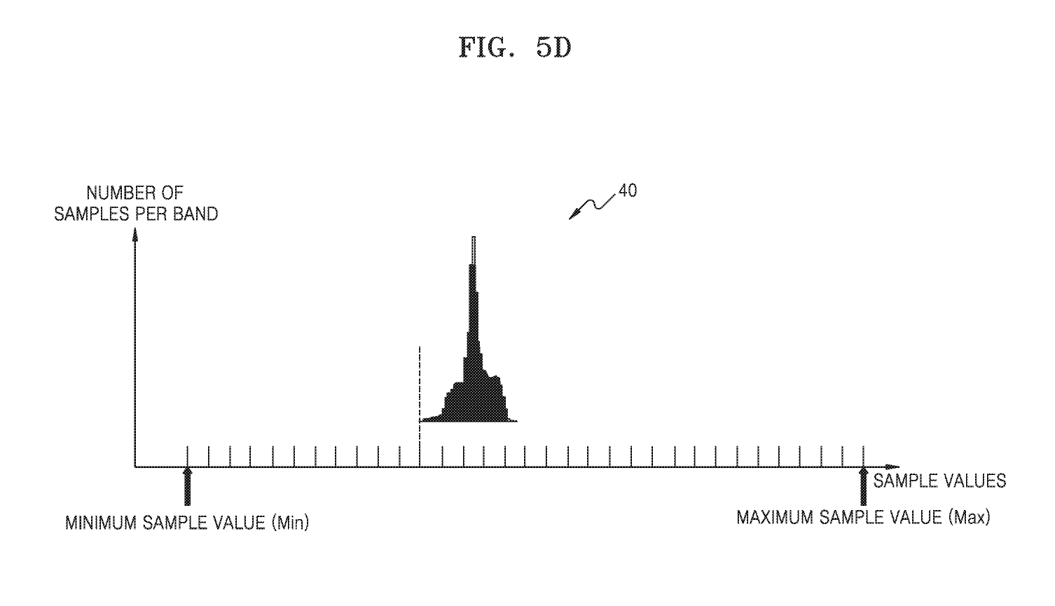

The offset determiner 192 may determine an offset type according to a method of classifying pixel values of the processing unit UT. An offset type according to an exemplary embodiment may be determined as an edge type or a band type. Depending on a method of classifying pixel values of a current block, whether to classify pixels of the current block according to an edge type or according to a band type may be determined. The classification of pixels according to either the edge type or the band type will be described in detail with reference to FIGS. 5A through 5D.

The offset determiner 192 may determine a value of each offset by using an SAO mode based on the dynamic range determined by the dynamic range determiner 191. Each offset may be determined, for example, according to a parameter indicating offset sign information, offset absolute value information, and offset scale information. In an exemplary embodiment, offsets may be derived using the following Equation 3.

Sao_Offset_Val=Sao_Offset_Sign*Sao_Offset_Abs«Sao_Offset_Scale [Equation 3]

In Equation 3, Sao_Offset_Val, Sao_Offset_Sign, Sao_Offset_Abs, and Sao_Offset_Scale are, for example, parameters indicating offsets, offset sign information, offset absolute value information, and offset scale information in the video parameter set of HEVC, respectively. In Equation 3, “«” indicates a left shift (or bit shift) operation.

That is, offsets may be derived by shifting a bit value for a product of the parameter indicating offset sign information and the parameter indicating offset absolute value information to the left by the parameter indicating offset scale information.

In an exemplary embodiment, the parameter indicating the offset scale information may be zero. That is, in this case, offsets may be derived as the bit value for the product of the parameter indicating offset sign information and the parameter indicating offset absolute value information. In another exemplary embodiment, the parameter indicating the offset scale information may be derived using the following Equation 4.

Sao_Offset_Scale=Max (0, Bitdepth−10) [Equation 4]

In Equation 4, Bitdepth is a bit depth for each pixel constituting a processing unit. That is, the parameter indicating offset scale information may be determined by a larger value of “a bit depth for each pixel, −10” and 0.

In an exemplary embodiment, a maximum value of the parameter indicating offset absolute value information may be determined as a function of the quantization parameter QP. If the maximum value of the parameter indicating offset absolute value information increases according to the quantization parameter QP, a dynamic range of each offset may increase.

The SAO compensator 193 may determine and output an appropriate SAO parameter SAO_PRM for the pixels constituting the processing unit UT based on values of offsets determined by the offset determiner 192, and SAO filtered data SAO_f_data may be output by performing SAO compensation on each of the pixels constituting the processing unit UT. The SAO parameter SAO_PRM may be independently determined for luminance components and color difference components. The SAO parameter SAO_PRM may include offset type information, offset class information, and/or offset values, and may be output to, for example, the entropy encoder 150 (of FIG. 1).

In an exemplary embodiment, the SAO compensator 193 may determine the SAO parameter SAO_PRM suitable for the processing unit UT using rate-distortion optimization (RDO). The SAO compensator 193 may determine, by using the RDO, whether to use a band offset type SAO, an edge offset type SAO, or not use any SAO.

FIG. 3B illustrates a dynamic range of offsets based on the quantization parameter QP, according to an exemplary embodiment.

Referring to FIGS. 3A and 3B, the dynamic range of offsets determined by the dynamic range determiner 191 may be different depending on a first quantization parameter QP1 or a second quantization parameter QP2. A first graph 11 may indicate a dynamic range of offsets according to the first quantization parameter QP1 and the second graph 12 may indicate a dynamic range of offsets according to the second quantization parameter QP2. The dynamic range of offsets may vary depending on a maximum value of an absolute value of the offsets, for example, in an SAO compensation.

The maximum value of the absolute value of the offsets according to an exemplary embodiment may be a function of the quantization parameter QP. For example, when the second quantization parameter QP2 is greater than the first quantization parameter QP1, the second function value f(QP2) according to the second quantization parameter QP2 may be equal to or greater than the first function value f(QP1) according to the first quantization parameter QP1. That is, the dynamic range according to the second quantization parameter QP2 may be equal to or greater than the dynamic range according to the first quantization parameter QP1.

As described above, in the video data encoder 100 (of FIG. 1), SAO filtering may be performed on video data based on offsets whose dynamic range is determined according to a quantization parameter QP. Therefore, the SAO filter 190 may enhance encoding efficiency in the SAO filtering operation when the quantization parameter QP has a small value, and an SAO filtering operation in which improved compensation may be performed when the quantization parameter QP has a large value.

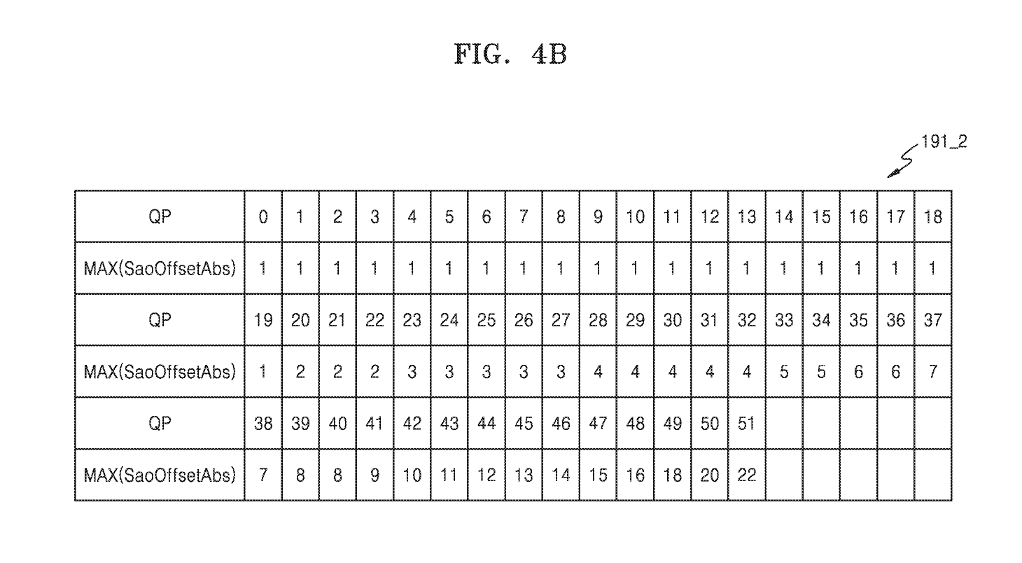

FIG. 4A is a block diagram of the dynamic range determiner 191 shown in FIG. 3A according to an exemplary embodiment, and FIG. 4B is a table of the configuration of the dynamic range determiner 191 shown in FIG. 3A according to an exemplary embodiment.

Referring to FIG. 4A, the dynamic range determiner 191 may include a calculation unit 191_1. The calculation unit 191_1 may receive the quantization parameter QP and calculate a maximum value of the parameter indicating offset absolute value information. In an exemplary embodiment, the maximum value of the parameter indicating offset absolute value information may be determined by the above-described Equation 2.

Referring to FIG. 4B, the dynamic range determiner 191 may include a first table 191_2. The first table 191_2 may be, for example, a table for a maximum value of an offset absolute value according to the quantization parameter QP. The dynamic range determiner 191 may find and output corresponding maximum value of an offset absolute value through the first table 191_2 based on the quantization parameter QP.

The first table 191_2 may store a value for at least one dynamic range defined according to the quantization parameter QP. In more detail, the first table 191_2 may store a maximum value of an offset absolute value represented by a function of the quantization parameter QP. In an exemplary embodiment, a maximum value of an offset absolute value may be derived using Equation 2. By Equation 2, a maximum value of an offset absolute value, that is, a dynamic range of offsets may be appropriately derived according to the quantization parameter QP.

FIG. 5A is a diagram of edge classes of an SAO edge type, FIGS. 5B and 5C are views of SAO categories of the SAO edge type, and FIG. 5D is a view of an SAO category of a SAO band type. Hereinafter, an SAO type, a category, and an offset sign in SAO filtering will be described in detail with reference to FIGS. 5A to 5D.

According to a technique of SAO filtering, samples may be classified according to (i) edge types constituted by restored samples, or (ii) band types of the restored samples. According to an exemplary embodiment, whether samples are classified according to the edge types or the band types may be determined by an SAO type.

First, classifying samples according to edge types will be described in detail, based on an SAO technique according to an exemplary embodiment, with reference to FIGS. 5A to 5D. The classification of samples according to edge types may be performed, for example, in the offset determiner 192 of FIG. 3A.

FIG. 5A illustrates edge classes of an SAO edge type. When offsets of an edge type for the processing unit UT is determined, edge classes of restored samples included in the current processing unit UT may be determined. That is, edge classes of current restored samples may be defined by comparing values of the current restored samples with values of neighboring samples. The processing unit UT may be, for example, a largest coding unit.

Indices of edge classes 21 through 24 may be allocated in an order of 0, 1, 2, and 3. As the occurrence frequency of an edge type increases, the index of the edge type may be decreased.

An edge class may indicate a direction of a one-dimensional edge formed by two neighboring samples adjacent to a current restored sample X0. The edge class 21 of index 0 may indicate a case in which two neighboring samples X1 and X2 adjacent to the current restored sample X0 in a horizontal direction form an edge. The edge class 22 of index 1 may indicate a case in which two neighboring samples X3 and X4 adjacent to the current restored sample X0 in a vertical direction form an edge. The edge class 23 of index 2 may indicate a case in which two neighboring samples X5 and X8 adjacent to the current restored sample X0 in a diagonal direction at 135° form an edge. The edge class 24 of index 3 may indicate a case in which two neighboring samples X6 and X7 adjacent to the current restored sample X0 in a diagonal direction at 45° form an edge. Therefore, edge classes of the current processing unit UT may be determined by analyzing edge directions of restored samples included in the current processing unit UT and determining a direction of a strong edge in the current processing unit UT.

For each edge class, categories may be classified according to an edge type of a current sample. An example of categories according to an edge type will be described with reference to FIGS. 5B and 5C.

FIGS. 5B and 5C illustrate categories of edge types according to an exemplary embodiment. In more detail, FIG. 5B illustrates conditions for determining a category of an edge, and FIG. 5C illustrates graphs of edge shapes and sample values c, a, and b of a restored sample and neighboring samples. The category of an edge may indicate whether a current sample is a lowest point of a concave edge, a sample of curved around the lowest point of the concave edge, a highest point of a convex edge, or a sample of curved corners around the highest point of the convex edge.

In FIGS. 5B and 5C, c may indicate an index of a restored sample, and a and b may indicate indices of neighboring samples adjacent to both sides of the current restored sample along an edge direction. Xa, Xb, and Xc may indicate values of the restored sample having indices a, b, and c, respectively. An X-axis of graphs of FIG. 5C may indicate indices of the restored sample and the neighboring samples adjacent to both sides of the restored sample, and a Y-axis may indicate values of the samples.

Category 1 may indicate a case in which the current sample is at a lowest point of a concave edge, that is, a local valley point (Xc<Xa && Xc<Xb). As shown in graph 31, a current restored sample c may be classified as Category 1 when the current restored sample c is at the lowest point of the concave edge between neighboring samples a and b.

Category 2 may indicate a case in which the current sample is at concave corners around a lowest point of a concave edge (Xc<Xa && Xc==Xb II Xc==Xa && Xc<Xb). The current restored sample c may be classified as Category 2 when the current restored sample c is located at an ending point of a falling curve of the concave edge (Xc<Xa && Xc==Xb) between the neighboring samples a and b as shown in graph 32, or when the current restored sample c is located at a starting point of a rising curve of the concave edge (Xc==Xa && Xc<Xb) as shown in graph 33.

Category 3 may indicate a case in which the current sample c is at convex corners around a highest point of a convex edge (Xc>Xa && Xc==Xb∥Xc==Xa && Xc>Xb). The current restored sample c may be classified as Category 3 when the current restored sample c is located at a starting point of a falling curve of the convex edge (Xc==Xa && Xc>Xb) between the neighboring samples a and b as shown in graph 34, or when the current restored sample c is located at an ending point of a rising curve of the convex edge (Xc>Xa && Xc==Xb) as shown in graph 35.

Category 4 may indicate a case in which the current sample c is at a highest point of a convex edge, that is, a local peak point (Xc>Xa && Xc>Xb). As shown in graph 36, the current restored sample c may be classified as Category 4 when the current restored sample c is at the highest point of the convex edge between the neighboring samples a and b.

If all of the conditions of categories 1, 2, 3, and 4 are not satisfied with respect to the current restored sample c, the current restored sample c may be classified as Category 0 because the current restored sample c is not an edge, and offsets for Category 0 may not be separately encoded.

In an exemplary embodiment, for restored samples corresponding to an identical category, an average value of differences between the restored samples and an original sample may be determined as offsets of a current category. Furthermore, offsets may be determined for each category.

Thereafter, an exemplary embodiment for classifying samples according to band types, based on an SAO technique according to an exemplary embodiment, will be described in detail with reference to FIG. 5D. The classification of samples according to band types may be performed, for example, in the offset determiner 192 of FIG. 3A.

In FIG. 5D, graph 40 shows values of restored samples and the number of samples per band. In an exemplary embodiment, each of the values of restored samples may belong to one of the bands. For example, a minimum value and a maximum value of sample values obtained according to p-bit sampling may be respectively Min and Max, and the total range of the sample values is Min, . . . , (Min+2^{p-1}=Max). When the total range (Min, Max) of the sample values is divided into K sample value intervals, each sample value interval may be referred to as a band. When Bₖ indicates a maximum value of a k^{th} band, bands may be divided into [B₀, B₁−1], [B₁, B₂−1], [B₂, B₃−1], . . . , [Bₖ₋₁, Bₖ]. When a value of a current restored sample belongs to [Bₖ₋₁, Bₖ], a current sample may be determined to belong to band k. Bands may be divided into equal types or non-equal types.

For example, when a band is an equal type band classified into 8 bit sample values, the sample values may be divided into 32 bands. In more detail, the sample values may be divided into bands [0, 7], [8, 15], . . . , [240, 247], and [248, 255].

Among a plurality of bands classified according to band types, a band to which each sample value belongs may be determined for each restored sample. Furthermore, an offset value indicating an average of errors between an original sample and the restored samples may be determined for each band.

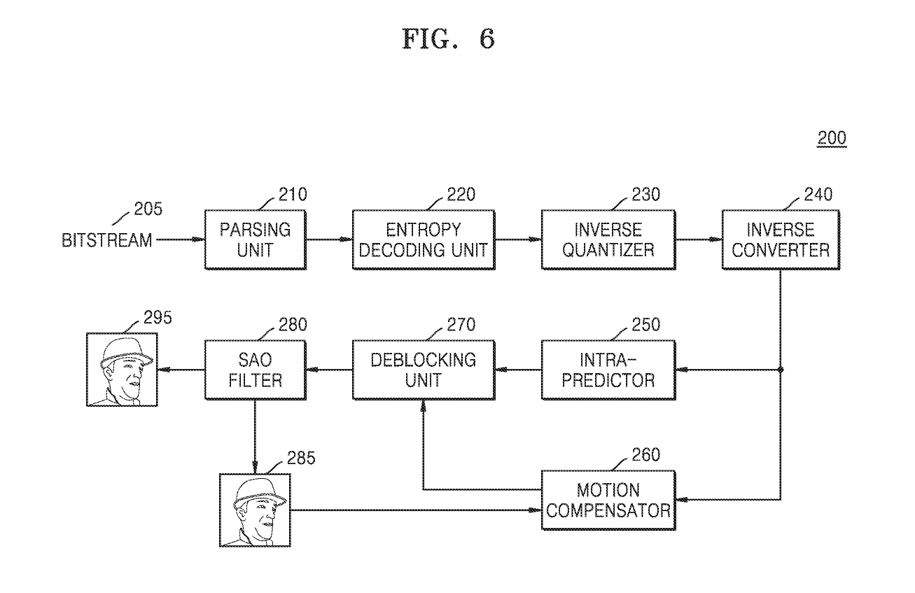

FIG. 6 is a block diagram of a configuration of a video data decoder 200 according to an exemplary embodiment.

Referring to FIG. 6, the video data decoder 200 may include a parsing unit 210, an entropy decoding unit 220, an inverse quantizer 230, and an inverse converter 240. Furthermore, the video data decoder 200 may include an intra-predictor 250, a motion compensator 260, a deblocking unit 270, and an SAO filter 280.

Encoded image data to be decoded and information about encoding necessary for decoding may be parsed through a bitstream 205 input to the parsing unit 210. The encoded image data is output as inverse quantized data through the entropy decoding unit 220 and the inverse quantizer 230, and image data in a spatial domain may be restored through the inverse converter 240. The information about encoding may include the SAO parameter SAO_PRM (of FIG. 2) and may be a basis of an SAO filtering operation in the SAO filter 280. The SAO parameter SAO_PRM (of FIG. 2) may include offset type information, offset class information, and/or offset values.

The intra-predictor 250 may perform intra-prediction on an intra-mode encoder for the image data in the spatial domain, and the motion compensator 260 may perform intra-prediction on the intra-mode encoder by using a reference frame 285. The image data in the spatial domain that has passed through the intra-predictor 250 and the motion compensator 260 may be post-processed through the deblocking unit 270 and the SAO filter 280 and output to a restored frame 295. Furthermore, the post-processed data through the deblocking unit 270 and the SAO filter 280 may be output as the reference frame 285.

In an exemplary embodiment, the parsing unit 210, the entropy decoding unit 220, the inverse quantizer 230, the inverse converter 240, the intra-predictor 250, the motion compensator 260, the deblocking unit 270, and the SAO filter 280 may perform operations based on, for example, encoding units according to a tree structure for each largest coding unit. In particular, the intra-predictor 250 and the motion compensator 260 may determine a partition and a prediction mode for each encoding unit according to a tree structure, and the inverse converter 240 may determine a size of a transform unit for each coding unit.

The SAO filter 280 may extract, for example, the SAO parameter SAO_PRM (of FIG. 2) of the largest coding units from the bitstream 205. In an exemplary embodiment, offset values of the SAO parameter SAO_PRM (of FIG. 2) of a current largest coding unit may be offset values whose dynamic range is determined according to the quantization parameter QP. The SAO filter 280 may use the offset type information and the offset values in the SAO parameter SAO_PRM (of FIG. 2) of the current largest coding unit and may adjust each restored pixel of a largest coding unit of the restored frame 295 by an offset value corresponding to a category according to edge types or band types.

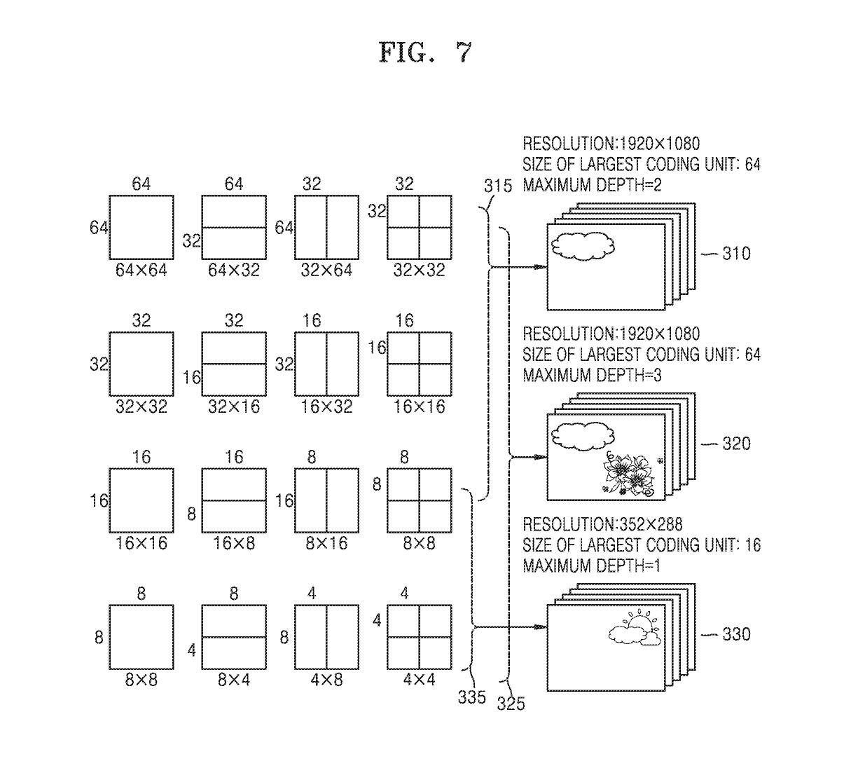

FIG. 7 is a conceptual diagram of a coding unit according to an exemplary embodiment.

Referring to FIG. 7, a size of the coding unit is represented by width×height, and may include 32×32, 16×16, and 8×8 from a coding unit of size 64×64. The coding unit of size 64×64 may be divided into partitions of sizes 64×64, 64×32, 32×64, and 32×32, the coding unit of size 32×32 may be divided into partition of sizes 32×32, 32×16, 16×32, and 16×16, the coding unit of size 16×16 may be divided into partition of sizes 16×16, 16×8, 8×16, and 8×8, and the coding unit of size 8×8 may be divided into partitions of sizes 8×8, 8×4, 4×8, and 4×4.

For first video data 310, a resolution may be set to 1920×1080, a size of a largest coding unit may be set to 64, and a maximum depth may be set to 2. For second video data 320, a resolution may be set to 1920×1080, a size of a largest coding unit may be set to 64, and a maximum depth may be set to 3. For third video data 330, a resolution may be set to 352×288, a size of a largest coding unit may be set to 16, and a maximum depth may be set to 1. The maximum depth shown in FIG. 7 may indicate the total number of divisions from the largest coding unit to a smallest coding unit.

It is desirable that a size of a largest coding unit is relatively large in order to improve coding efficiency and to accurately reflect image characteristics when a resolution is high or the amount of data is large. Accordingly, a size of a largest coding unit of first or second video data 310 or 320 having a resolution higher than third video data 330 may be selected as 64.

Because the maximum depth of the first video data 310 is 2, a coding unit 315 of the first video data 310 may include from a largest coding unit having a long axis size of 64 to coding units whose long axis sizes are 32 and 16, as depths are deepened in two layers by being split twice. On the other hand, because the maximum depth of the third video data 330 is 1, a coding unit 335 of the third video data 330 may include from a largest coding unit having a long axis size of 16 to coding units whose long axis size is 8 as depths are deepened in one layer by being split once.

Because the maximum depth of the second video data 320 is 3, a coding unit 325 of the second video data 320 may include from a largest coding unit having a long axis size of 64 to coding units whose long axis sizes are 32, 16, and 8 as depths are deepened in three layers by being split three times. The deeper the depth, the better the ability to express detailed information.

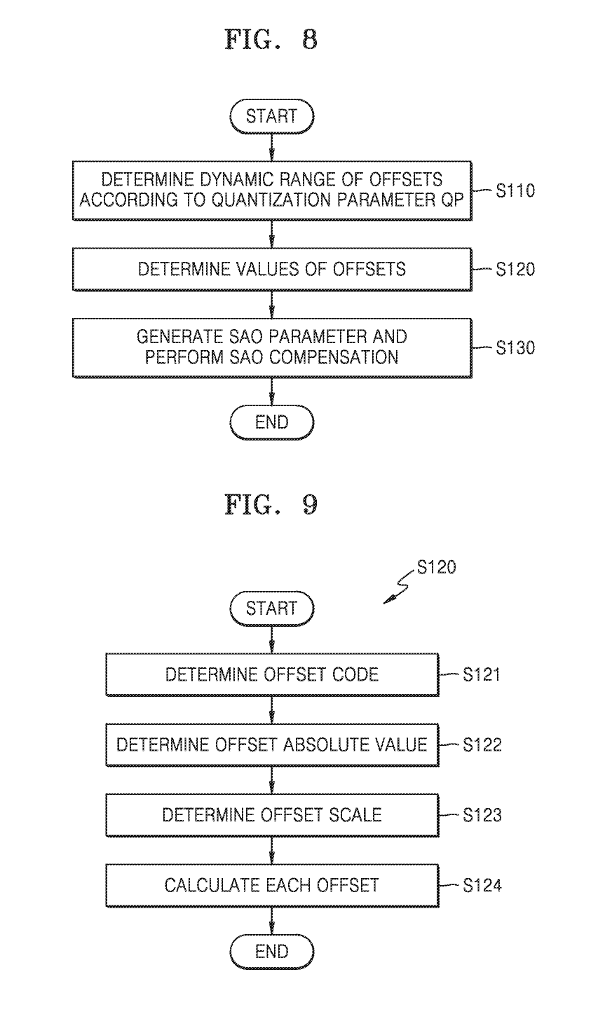

FIG. 8 is a flowchart of an operation of the SAO filter 190 according to an exemplary embodiment. FIG. 8 shows an example of an operation of the SAO filter 190 shown in FIGS. 1 and 3A.

Referring to FIG. 8, in operation S110, the SAO filter 190 may determine a dynamic range of offsets according to the quantization parameter QP. In an exemplary embodiment, operation S110 of determining the dynamic range may be performed in the dynamic range determiner 191 based on the quantization parameter QP. The quantization parameter QP may be output, for example, from the quantizer 140. In an exemplary embodiment, the dynamic range may be derived from the above-described Equation 2. Operation S110 of determining the dynamic range may be performed, for example, on a largest coding unit basis.

In operation S120, values of offsets for SAO filtering may be determined after operation S110 of determining the dynamic range for offsets. In an exemplary embodiment, operation S120 of determining offset values may be performed in the offset determiner 192. In operation S120 of determining the offset values, each offset value may be determined by using an SAO mode based on the dynamic range determined in operation S110.

In operation 5130, the SAO parameter SAO_PRM may be generated and SAO compensation may be performed based on the offset values. In an exemplary embodiment, operation S130 of generating the SAO parameter SAO_PRM and performing the SAO compensation may be performed in the SAO compensator 193. The SAO compensation may be performed on pixels constituting the processing unit UT, and the processing unit UT may be, for example, the largest coding unit. The SAO parameter SAO_PRM may include offset type information, offset class information, and/or offset values, and may be output as a bitstream, for example, through entropy encoding.

FIG. 9 is a flowchart of determining values of offsets, according to an exemplary embodiment. FIG. 9 shows an example of an operation of the offset determiner 192 shown in FIG. 3A and may correspond to operation S120 in FIG. 8.

Referring to FIG. 9, in operation S121, the offset determiner 192 may determine an offset sign, and in operation S122, may determine an offset absolute value. In an exemplary embodiment, a maximum value of the offset absolute value may be determined by the dynamic range determiner 191 based on the quantization parameter QP.

In operation S123, an offset scale may be determined after operation S122 of determining the offset absolute value. In an exemplary embodiment, in operation S123 of determining the offset scale, the offset scale may be determined through the above-described Equation 4. In another exemplary embodiment, the offset scale may be determined to be 0 in operation S123 of determining the offset scale.

In operation S124, each offset may be calculated with the offset sign, the offset absolute value, and the offset scale. In an exemplary embodiment, each offset may be derived by operation S124 of calculating the offsets by the above-described Equation 3.

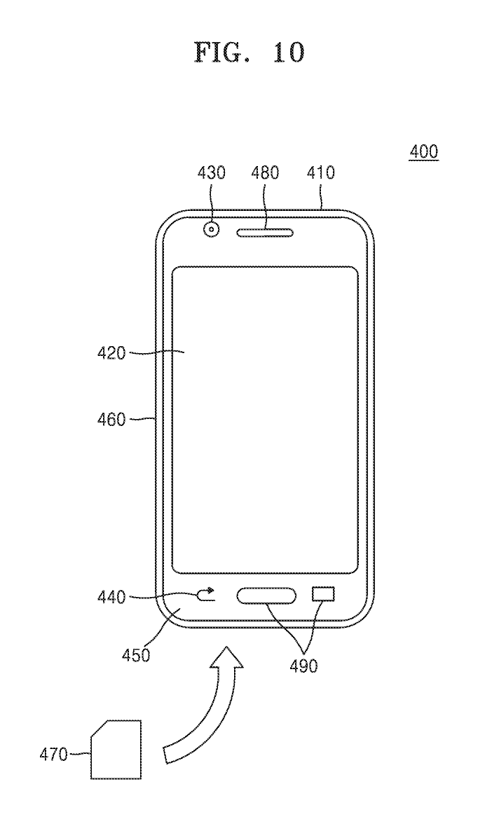

FIG. 10 illustrates a mobile terminal 400 equipped with a video data encoder according to an exemplary embodiment. The mobile terminal 400 may be equipped with an application processor including, for example, a video data encoder according to an exemplary embodiment.

The mobile terminal 400 may be a smart phone that may modify or extend many functions through an application program. The mobile terminal 400 may include an antenna 410 and a display screen 420 such as a liquid crystal display (LCD) for displaying images captured by a camera 430 or images received by the antenna 410, or an organic light-emitting diode (OLED) screen. The mobile terminal 400 may include an operation panel 440 including one or more control buttons 490 and a touch panel. In addition, when the display screen 420 is a touch screen, the operation panel 440 may further include a touch sensing panel of the display screen 420. The mobile terminal 400 may include a speaker 480 or another type of sound output unit for outputting voice and sound, and a microphone 450 or another type of sound input unit for inputting voice and sound. The mobile terminal 400 may further include the camera 430 such as a charge coupled device (CCD) or a complementary metal oxide semiconductor (CMOS) for capturing video and still images. Furthermore, the mobile terminal 400 may include a storage medium 470 for storing encoded or decoded data such as video or still images captured by the camera 430, received via e-mail, or acquired in another form, and a slot 460 for inserting the storage medium 470 in the mobile terminal 400. The storage medium 470 may be another type of flash memory such as a secure digital (SD) card or an electrically erasable and programmable read-only memory (EEPROM) embedded in a plastic case.

As will be understood by the skilled artisan, the encoding and decoding methods and apparatuses according to exemplary embodiments may be implemented as software or hardware components, such as a Field Programmable Gate Array (FPGA) or Application Specific Integrated Circuit (ASIC), which performs certain tasks. A unit or module may advantageously be configured as computer-readable codes to be stored on the addressable storage medium (memory) and configured to execute on one or more processors or microprocessors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or modules or further separated into additional components and units or modules. While the inventive concept has been particularly shown and described with reference to example embodiments thereof, it will be understood that various changes in form and details may be made therein without departing from the spirit and scope of the following claims.

What is claimed is:

1. A method of encoding video data, the method comprising:
determining a range of a plurality of offsets based on a quantization parameter;
determining values of offsets in the range of the plurality of offsets based on a sample adaptive offset (SAO) mode; and
performing SAO compensation on pixels of a coding unit based on the values of the offsets.

2. The method of claim 1, wherein the SAO mode includes a band offset mode or an edge offset mode.

3. The method of claim 1, wherein the determining of the values of offsets comprises:
determining a value of a parameter indicating offset sign information;
determining a value of a parameter indicating offset absolute value information;
determining a value of a parameter indicating offset scale value information; and
calculating the values of the offsets based on the value of the parameter indicating offset sign information, the value of the parameter indicating offset absolute value information, and the value of the parameter indicating offset scale information.

4. The method of claim 3, wherein the calculating comprises:
shifting a bit value for a product of the value of the parameter indicating offset sign information and the value of the parameter indicating offset absolute value information to the left by the value of the parameter indicating offset scale information.

5. The method of claim 3, wherein the determining of the range comprises determining a maximum value of the parameter indicating offset absolute value information as a function of the quantization parameter.

6. The method of claim 5, wherein, when a first function value according to a first quantization parameter and a second function value according to a second quantization parameter larger than the first quantization parameter are respectively derived according to the function of the quantization parameter, the second function value is equal to or greater than the first function value.

7. The method of claim 5, wherein the determining of the range comprises determining a maximum value of the parameter indicating offset absolute value information as a rounded value of 0.5*e^{(0.07*quantization parameter)}.

8. The method of claim 1, wherein the determining of the range comprises determining the range based on a table in which a value for at least one dynamic range defined according to the quantization parameter is stored.

9. A video data encoder comprising:
a memory configured to store computer-readable instructions for encoding video data; and
a processor configured to execute the computer-readable instructions to implement:
a quantizer configured to quantize the video data based on a quantization parameter; and
a sample adaptive offset (SAO) filter configured to perform SAO filtering on pixels of a coding unit of the quantized video data according to values of offsets in a range of offsets determined based on the quantization parameter.

10. The video data encoder of claim 9, wherein the SAO filter comprises:
a dynamic range determiner configured to determine the range of offsets based on the quantization parameter;
an offset determiner configured to determine the values of the offsets by using an SAO mode based on the range of offsets; and
an SAO compensator configured to perform SAO compensation the pixels of the coding unit based on the values of the offsets determined by the offset determiner.

11. The video data encoder of claim 10, wherein the dynamic range determiner is further configured to determine a first range based on a first quantization parameter and determine a second range based on a second quantization parameter having a value greater than the first quantization parameter, and the second range is equal to or wider than the first range.

12. The video data encoder of claim 10, wherein the dynamic range determiner is further configured to determine a maximum absolute value of the offsets as a function of the quantization parameter.

13. The video data encoder of claim 12, wherein the function of the quantization parameter is 0.5*e^{(0.07*quantization parameter)}.

14. The video data encoder of claim 10, further comprising:
a first table configured to store a value for at least one range defined according to the quantization parameter, and
the dynamic range determiner is further configured to determine the range based on the value for the at least one range stored in the first table.

15. The video data encoder of claim 14, wherein a value for the range is a maximum value for an absolute value of each of the offsets represented by a function of the quantization parameter.

16. A video encoding method comprising:
determining a range of offsets based on a quantization parameter (QP);
determining sample adaptive offset (SAO) values of bands of offsets in the range of offsets based on errors between original samples and restored samples in the bands of offsets;
determining an SAO edge type of a sample of a coding unit to be encoded;
determining a sample band among the bands of offsets to which the sampled pixel belongs based on SAO edge type;
determining an SAO value to be applied for SAO compensation on the sample based on the SAO value of the sample band among the bands of offsets to which the sample belongs; and
performing SAO compensation on the sample based on the SAO value.

17. The video encoding method of claim 16, wherein the range of offsets is determined based on a maximum value of an offset absolute value in a video parameter set (VPS).

18. The video encoding method of claim 17, wherein the range of offsets is based on a size of a largest coding unit of video data to be encoded.

19. The video encoding method of claim 18, wherein the SAO values of the bands of offsets in the range of offsets are determined based on offset sign information, offset absolute value information, and offset scale information in the VPS.

20. The video encoding method of claim 19, further comprising selecting the QP from among a first QP and a second QP having a value greater than the first QP.
